(19) United States
(12) Patent Application Publication
(10) Pub. No.: US 2016/0268654 A1
(43) Pub. Date: Sep. 15, 2016

(54) COST-EFFICIENT DEVICE FOR CONTROLLING THE TEMPERATURE OF A MOTOR VEHICLE BATTERY MODULE, AND MANUFACTURING METHOD

(71) Applicant: VALEO SYSTEMES THERMIQUES, Le Mesnil Saint Denis (FR)

(72) Inventors: Gilles Elliot, Courcouronnes (FR); Vincent Feuillard, Le Mesnil St. Denis (FR); Philippe Doucet, Sable Sur Sarthe (FR); Alain Pourmarin, La Suze-Sur-Sarthe (FR)

(73) Assignee: VALEO SYSTEMES THERMIQUES, Le Mesnil Saint Denis (FR)

(21) Appl. No.: 15/028,171

(22) PCT Filed: Oct. 6, 2014
(86) PCT No.: PCT/EP2014/071360

§ 371 Date: Apr. 8, 2016

(30) Foreign Application Priority Data
Oct. 10, 2013 (FR) 1359826

(51) Int. Cl. H01M 10/625; H01M 10/6556; F28D 15/02; H01M 10/6552

(52) U.S. Cl. CPC H01M 10/625; H01M 10/6552; H01M 10/6556; F28D 15/0275; H01M 2220/20

(57) ABSTRACT

The invention relates to a device for controlling the temperature of a motor vehicle battery module, comprising a beat exchanger (3) and a bundle of heat pipes (5) having at least one surface for making thermal contact with a battery of the motor vehicle and moreover with the heat exchanger (3). Said heat exchanger comprises at least one inner wall, making contact with said heat pipe surface, and at least one outer wall defining, with said inner wall, a space wherein a heat-transport fluid may flow. Said heat exchanger also comprises at least one input nozzle (20) and at least one output nozzle (21) for said fluid to flow therethrough. Said temperature control device is characterized in that said inner and outer walls are made of an aluminum or aluminum alloy sheet by a cold-forming operation and are assembled to one another by crimping, such as to form said fluid flow space.

The invention relates to a thermal control device for a motor vehicle battery module, for cooling or heating the battery or batteries of a motor vehicle, notably an electric motor vehicle, of the hybrid or all-electric type. The invention also relates to a method for manufacturing said control device.

In order to ensure optimal functioning and an optimal duration of use of the batteries of a vehicle with an electric motor, notably batteries of the lithium-ion type, the temperature of the batteries should be maintained in a range of around 15° C. to 35° C. and more specifically between 20 and 30° C.

This maintaining of the temperature should be ensured when the vehicle is running and when it is stopped, and more particularly while the batteries are being charged. Very rapid charging of the battery can cause a very large amount of heat to be generated in the battery. It is then necessary to cool the battery in order to preserve its service life. Similarly, depending on the climatic conditions, notably in winter or in cold countries, it may be necessary to heat the battery in order to remain within the temperature range for optimal functioning.

On account of the particularly high cost of the batteries with respect to the overall cost of the vehicle, it is essential to provide means for controlling the temperature of the batteries that are effective. There is also currently a desire to obtain means for controlling the temperature of batteries which have a relatively small bulk and weight, which are simple and have a good performance/price ratio.

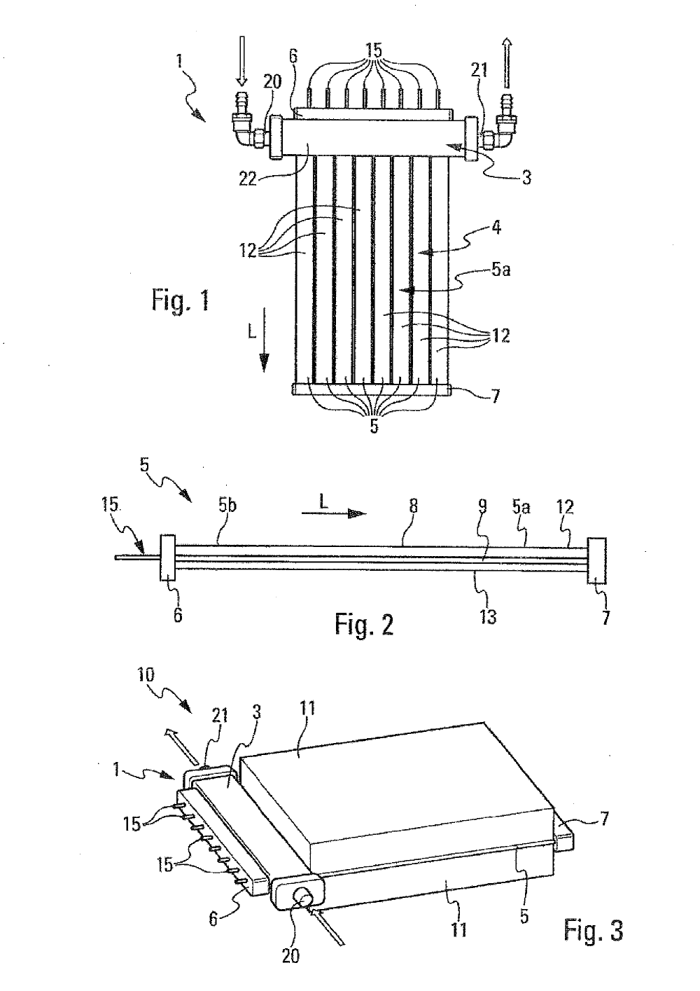

To this end, devices have been proposed which are illustrated and will be described in more detail with reference to FIG. 1. They generally comprise a heat exchanger and a bundle of heat pipes arranged in a substantially parallel manner. The heat pipes have first ends, one surface of which is intended to be in thermal contact with a battery of the motor vehicle, and second ends, one surface of which is in thermal contact with the heat exchanger. They each have a filling plug, a shut-off plug and a central body delimiting a plurality of distribution channels in which a phase change fluid is enclosed. For its part, the heat exchanger comprises a fluid inlet, a fluid outlet and at least two tubes defining two circuits for guiding the distribution of a heat transfer fluid between its inlet and its outlet. The axis of each tube is oriented substantially perpendicularly to the longitudinal direction of the heat pipes and the second ends of the heat pipes thus each have a surface in thermal contact with one of the tubes.

In the prior art, the tubes of the heat exchanger are produced by methods, for example electro-welding, that limit the possibilities for producing the heat exchanger at low cost.

The object of the present invention is thus to propose an improved thermal control device for a motor vehicle battery module, which functions similarly to the one described above, but which is more simple and less expensive to manufacture.

To this end, the subject of the invention is a thermal control device for a motor vehicle battery module, comprising a heat exchanger and a bundle of heat pipes having at least one surface intended to be in thermal contact both with a battery of the motor vehicle and with the heat exchanger, said heat exchanger comprising at least one inner wall in contact with said surface of the heat pipes and at least one outer wall that delimits with said inner wall a circulation space for a fluid.

According to the invention, said inner and outer walls each comprise a plate. The use of separate plates for producing the inner wall and the outer wall affords numerous possibilities for improving the heat exchanger.

According to a first example, said inner wall is covered on its two faces with a filler metal and said outer wall is covered with said filler metal on only one of its faces, situated facing said circulation space. In this way it is possible to avoid brazing the heat exchanger on its brazing support while the heat exchanger is being manufactured.

According to another example, said plates are for example produced, from a metal sheet, notably made of aluminum or an aluminum alloy, by a cold forming operation. Such a method is extremely simple and makes it possible to produce thermal control devices at a lower cost. Said plates may be preassembled together by crimping so as to form said circulation space.

Said fluid circulating in the heat exchanger is, for example, a heat transfer fluid. It may also be, notably, a refrigerant fluid.

Said heat exchanger may also comprise at least one inlet nozzle and at least one outlet nozzle for the circulation of said fluid.

Advantageously, said heat exchanger can comprise two elements that each comprise an inner wall and an outer wall and are intended to be in thermal contact with two faces of said heat pipes, said elements being geometrically identical. A larger reduction in costs is thus achieved by reducing the number of component parts to be produced, and by doubling the length of the series for manufacturing these elements.

In one particular embodiment, the two elements are in contact with one another over at least a part of their inner walls and are positioned with respect to one another following rotation through 180°.

Preferably, the circulation spaces of the two elements are brought into communication with one another, the heat exchanger only comprising a single inlet nozzle and a single outlet nozzle. This configuration allows a further reduction in costs, with the elimination of the manufacture of one nozzle in two.

Longitudinal ends of said plates may comprise pressings at which the contact between the two elements is realized. The pressings of the plate forming the inner wall of said elements advantageously have an opposite orientation on each side of the corresponding plate so as to create a depression for accommodating a longitudinal end of the other element.

Said longitudinal ends of the elements that are fitted in said depressions comprise openings for the introduction of said inlet and/or outlet nozzles.

Preferably, the heat pipes are closed by a filling plug at their end situated by the heat exchanger. Said plug is preferably produced from a metal sheet, notably made of aluminum or an aluminum alloy, by a cold forming operation.

The same reduction in cost is thus applied to the filling plug as is obtained with the elements of the heat exchanger.

More preferably, at least one wall of the filling plug is produced in one piece with at least one of the walls of said heat exchanger.

Advantageously, the filling plug is formed by wall extensions of the two elements of said heat exchanger, said wall extensions being assembled together. This production method further reduces the number of component parts to be produced.

Preferably, a joining line of said extensions comprises, along its length, openings that are able to form access points to the internal cavities of the heat pipes in order to fill them with fluid. This method makes it possible to avoid having to produce pumping tubes which would then have to be joined to the other elements of the device.

The invention also relates to a motor vehicle battery module comprising at least one battery, characterized in that it comprises at least one thermal control device as described above.

Preferably, said battery module is characterized in that it comprises at least two batteries that are stacked one on top of another with a thermal control device interposed between two successive batteries.

The invention also relates to a method for manufacturing a thermal control device for a motor vehicle battery module as described above, characterized in that:
the heat pipes and the inner and outer walls of the element(s) intended to form the heat exchanger are manufactured separately, said walls being produced by cold forming,
said element(s) are closed by, if need be, positioning one or more disruptors beforehand inside the heat exchanger so as to form a circulation space for a heat transfer fluid,
the assembly is brazed simultaneously.

More specifically, the method according to the invention may be implemented as follows:
in a first step, the heat pipes, the plugs for filling and evacuating said heat pipes, the inner and outer walls of the element(s) intended to form the heat exchanger, said walls being produced by cold forming, the inlet and outlet nozzles of said heat exchanger, and optionally one or more disruptors are manufactured separately,
before or after said cold forming is carried out, the two faces of the inner walls of the elements of the heat exchanger, one face of the outer walls of said heat exchanger, and the internal walls of said plugs are covered with a layer of filler metal for brazing,
the ends of said element(s) which are not intended to be brazed are closed by crimping by, if need be, positioning said disruptor(s) beforehand inside the heat exchanger so as to form a circulation space for a heat transfer fluid,
then the above elements are assembled in a holding tool, and
the assembly is brazed simultaneously, in an oven, by melting of the filler metal.

Preferably, the filling plug is formed by two walls produced by a cold forming operation, said walls meeting at a joining line in the holding tool and being covered with filler metal at said joining line for brazing along this line during the final assembly step.

Advantageously, said walls of the filling plug are produced in continuation of the inner or outer walls of the elements of said heat exchanger, during the same cold forming operation.

Preferably, the operation of forming said walls of the filling plug is carried out by making indentations in one of the edges of said walls, so as to generate openings along the joining line of the two walls.

In one particular embodiment, pumping tubes are positioned in the holding tool at said joining line, said pumping tubes being brazed to the filling plug during the simultaneous brazing of the other elements.

Further features and advantages of the invention will become more clearly apparent from reading the following description, which is given by way of illustrative and nonlimiting example, and from the appended drawings, in which:

FIG. 1 shows a front view of a thermal control device for a motor vehicle battery module according to the prior art,

FIG. 2 shows a schematic and perspective side view of a heat pipe of the device in FIG. 1,

FIG. 3 shows a schematic and perspective view of an example of a battery module comprising two batteries and the thermal control device in FIG. 1,

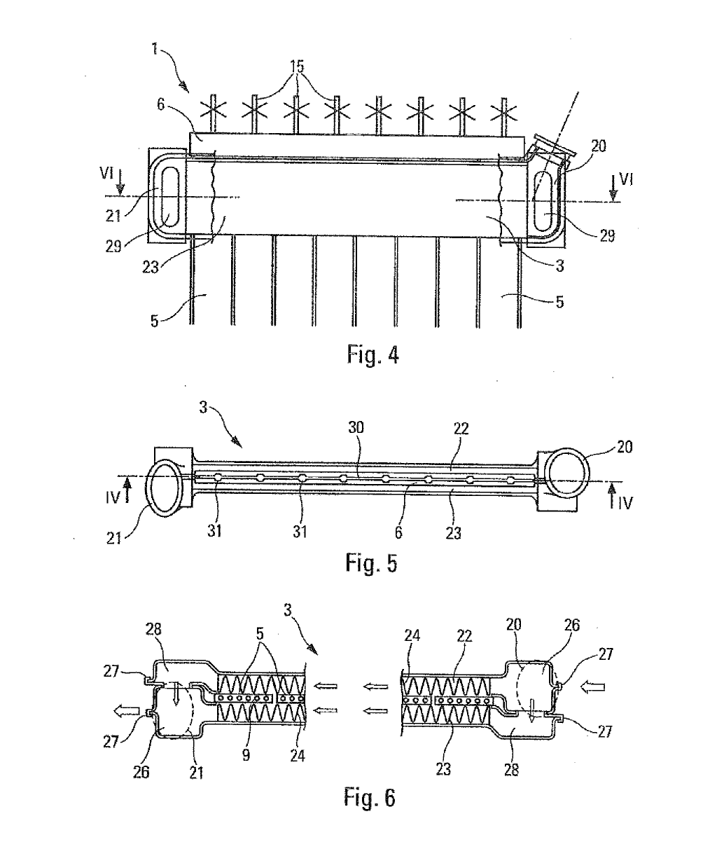

FIG. 4 shows a front view in partial section of one embodiment of a thermal control device according to the invention,

FIG. 5 shows a top view of one embodiment of the device in FIG. 4, and

FIG. 6 shows a top view in section of the same thermal control device.

FIG. 1 shows a thermal control device 1, according to the prior art, for a motor vehicle battery module, notably of an electric vehicle, of the hybrid or all-electric type.

The thermal control device 1 conventionally comprises a heat exchanger 3 and a bundle of heat pipes. The device 1 illustrated in FIG. 1 thus comprises a bundle 4 comprising eight heat pipes 5.

In a manner known per se, a heat pipe 5 is in the form of a hermetic enclosure which contains a fluid with its gaseous phase and its liquid phase in equilibrium, in the absence of any other gas. It is thus a diphasic fluid. An organic fluid, i.e. one comprising molecules of carbon, hydrogen, and oxygen, can be mentioned as a nonlimiting example.

The heat pipe 5 has an elongate overall shape along a longitudinal axis L (FIGS. 1 and 2). According to the example schematically shown in FIG. 2, it comprises a filling plug 6, a shut-off plug 7 and a central body 8 defining a plurality of ducts (only one of which is shown in FIG. 2) extending in a distributing manner between the filling plug 6 and the shut-off plug 7.

The ducts 9 are for example identical and parallel to one another inside the central body 8. Their internal walls have profiles configured to guide the liquid by capillary action from one end of the heat pipe 5 to the other.

According to one particular embodiment, illustrated in FIGS. 1 to 4, each heat pipe 5 can also comprise a pumping tube 15 which makes it possible to communicate with the inside of the hermetic enclosure of the heat pipe in order to fill it with or empty it of its diphasic fluid. The pumping tube 15 is thus inserted and fixed in a leaktight manner to the filling plug 6. Alternatively, the heat pipes 2 may have a closable hole, formed in the filling plug 6, which communicates directly with the inside of the hermetic enclosure for filling the heat pipe 5. Access to the internal cavity of the heat pipe thus takes place, without a pumping tube, by the introduction of a syringe, or any other similar device, into this closable hole.

In other words, in this case, the ducts 9 are closed at a first end by the filling plug 6 and at a second end by the shut-off plug 7. The filling plug 6 comprises, at the first end of the central body 8, a groove transverse to the longitudinal direction L of the heat pipes, which allows the ducts 9 of one and the same heat pipe to be in fluidic communication with one another. In the same way, the shut-off plug 7 comprises, at the second end of the central body 8, a second means for bringing the ducts 9 into communication with one another. These communication means make it possible to balance the pressure between all of the different ducts 9 of the heat pipe 5 so as to distribute the diphasic fluid equally through the hermetic enclosure defined by the communication grooves and the ducts 9. The filling plug 6 and shut-off plug 7 thus have the functions of allowing communication between the ducts 9 of the heat pipe 5, closing the ducts 9 from the outside and optionally fitting pumping tubes 15 for emptying/filling the heat pipe 5.

As far as their technological production is concerned, the heat pipes 5 (central bodies 8, filling plugs 6, shut-off plugs 7 and optional pumping tubes 15) are, as is known, made of a metal material, for example entirely of aluminum which has excellent thermal conductivity. The multiduct central bodies 8 are made for example by extrusion and then cut to the desired length. For their part, the pumping tubes 15 are brazed to the filling plug 6, thereby ensuring that the assembly is leaktight.

As far as the heat exchanger 3 is concerned, it comprises, in a conventional manner, two tubes 22, 23 that define two circuits for guiding the circulation of a fluid, such as water or glycol water, in a distributed manner between the fluid inlet 20 and the fluid outlet 21 (see arrows in FIG. 1 or 6). The axes of the tubes 22, 23 are oriented substantially perpendicularly to the longitudinal direction L of the heat pipes 5. The second ends 5b of the heat pipes 5 of the bundle 4 are interposed between the two tubes 22, 23, which sandwich them, each of the two ends 5b thus having a surface in thermal contact with one of the tubes 22 or 23.

In “cooling” operation, a “cold” fluid enters through the fluid inlet 20, passes through the guide circuits of the tubes 22, 23 and exits through the fluid outlet 21. On passing through the tubes 22, 23, the fluid collects the energy of the heat pipes 5 and evacuates it into a fluid system connected to the fluid outlet 21. The fluid system evacuates the heat surplus, for example through an outer radiator at the front of the vehicle. Alternatively, the cold fluid is cooled by a refrigerant fluid of an air conditioning loop of the vehicle. The tubes 22, 23 thus make it possible to dissipate the accumulated heat through the second ends 5b of the heat pipes 5. By contrast, in “heating” operation, it is a “hot” fluid which passes through the guide circuits of the tubes 22, 23 and which transfers energy to the heat pipes 5. The circulation of the fluid through the tubes 22, 23 is thus used to provide or dissipate heat to the heat pipes 5 without increasing the bulk of the battery module 10.

In order to improve the heat transfer to the fluid passing through the tubes 22, 23, provision is made for the tubes 22, 23 to comprise a turbulator 24, housed in the guide circuit (visible in FIG. 6). The turbulator 24 extends along the guide circuit and has for example a substantially wavy shape in the transverse direction of the tubes 22, 23. The waves of the turbulator 24 thus form heat exchange fins, thereby promoting heat exchange between the fluid passing through the tubes 22, 23 and the tubes 22, 23.

The fins of the turbulators 24 are for example metallic, such as made of an aluminum material and are brazed to the internal walls of the tubes 22, 23 in the guide circuits of the heat exchanger 3, for example at the crests of their waves.

The control device 1 is incorporated into a motor vehicle battery module 10 that also comprises at least one battery 11. FIG. 3 illustrates an example of a battery module 10 comprising two batteries 11 and a control device 1. The batteries 11 are for example electrochemical, in particular of the lithium-ion type. Such batteries have the advantage of having a good weight/power ratio: that is to say they are powerful with respect to their compactness.

In the example illustrated, the battery 11 has a substantially parallelepipedal shape with two planar parallel large faces. By way of example, the surface area of the planar large surfaces is of the order of an A4 format (300*216 mm).

The thermal control device 1 is joined to the batteries such that the first ends 5a of the heat pipes 5 are in thermal contact with the battery or batteries 11 and the second ends 5b of the heat pipes 5 are in thermal contact with the heat exchanger 3 (FIGS. 1 and 3). The expression “thermal contact” is understood as meaning either that the surfaces 12, 13 of the first ends 5a of the heat pipes 5 are pressed and fixed against the battery 11 in direct contact therewith, without an intermediary, or that these surfaces are pressed and fixed against the battery 11 with interposition of a thermally conductive interface that promotes heat exchange between the battery 11 and the heat pipe 5.

The battery module 10 can thus comprise a plurality of batteries 11 and a plurality of thermal control devices 1, the batteries 11 being stacked one on top of another, large face against large face, with a thermal control device 1 being interposed between two successive batteries 11, as shown in FIG. 3.

In order to maximize the heat exchange area between the heat pipes 5 and the batteries 11, provision is made that, within one and the same bundle 5, the heat pipes 5 are disposed in parallel, that is to say they are parallel to one another and parallel to the longitudinal axis L, and that the surfaces 12, 13 of the first ends 5a of the heat pipes 5 entirely cover the surface of the large face of the battery 11. The thermal control device 1 thus makes it possible to control the temperature of the batteries 11 as close as possible thereto, with a large heat exchange area, virtually the entire surface area of the battery 11, being intimately interposed therebetween, in a simple manner and with reduced bulk.

Referring now to FIGS. 4 to 6, a thermal control device according to the invention will be described.

Whereas in the prior art, the heat exchanger 3 was produced from a rectangular metal strip, made of aluminum or an aluminum alloy, which was folded and then brazed or electro-welded, the invention proposes producing the tubes 22 and 23 in the form of two plates or two half-shells which are each obtained from two sheets of aluminum that are folded and cold formed, for example by crimping, and then joined together by crimping so as to define a space for circulation of the fluid passing through the heat exchanger. A first of the plates forms an inner wall in contact with the heat pipes and a second of the plates forms an opposite outer wall. Fixed to each of the ends of the exchanger, preferably by brazing, are an inlet nozzle 20 and outlet nozzle 21 for the cooling fluid, which are positioned so as to be in communication with the circulation space for said fluid.

Each of the tubes 22 or 23 thus has a substantially parallelepipedal shape extending transversely to the longitudinal direction L, the two aluminum plates which make it up being parallel to and spaced apart from one another by a constant length over the entire face which is parallel to the bundle 4 of heat pipes 5. Nevertheless, they have, at one of their transverse ends, a bulge 26 with a greater thickness, so as to be able to fix the corresponding inlet nozzle 20 or outlet nozzle 21 thereto and to adapt its diameter to the flow of fluid entering or exiting through this nozzle. Said bulges are made for example in the form of pressed portions of said plates. The two aluminum sheets meet at their transverse ends or are fixed to one another by a crimp 27 which ensures the hydraulic leaktightness of the inside of the tube.

In order to obtain a greater reduction in the manufacturing costs, the invention proposes, rather than giving the two tubes 22 and 23 shapes which are symmetrical to one another with respect to the central plane of the device, giving them an identical shape and then positioning them head-to-tail with respect to one another, that is to say in positions which are symmetrical to one another with respect to a central axis oriented in the longitudinal direction L. For this purpose, the transverse end 28 of the tubes 22 and 23, which is away from that with the bulge 26, extends away from the central plane of the device so as to leave space for accommodating therein a part of the protuberance associated with the bulge 26 of the other tube and thereby to give the assembly formed by the two tubes an outer shape which is substantially symmetrical with respect to this central plane. In other words, the pressings of the plate forming the inner wall of said elements advantageously have an opposite orientation at each longitudinal end of the corresponding plate so as to create a depression for accommodating a longitudinal end of the other element.

The circulation of the cooling fluid inside the heat exchanger 3 is preferably realized by a single inlet nozzle 20 and a single outlet nozzle 21, the flow splitting at the inlet nozzle in order to be distributed between the two tubes and then coming together at the outlet nozzle. For this purpose, the walls of each of the tubes are pierced, at the point of contact between the bulge 26 of one tube and the transverse end 28 of the other tube, by pierced holes 29 (visible in FIG. 4) which bring the two entities into communication and which form a passage for the fluid, a part of which can thus pass from the tube 22, which bears the inlet nozzle 20, into the tube 23, which bears the outlet nozzle 21. At the other transverse end of the heat exchanger 3, an identical passage 29 allows the part of the fluid which has traveled through the tube 22 to pass into the tube 23, and then into the outlet nozzle.

Referring now more particularly to FIGS. 4 and 5, two embodiments of the thermal control device 1 can be seen, as far as the means for filling the heat pipes 5 is concerned.

FIG. 4 shows a heat exchanger 3 which is produced independently of the filling plug 6. In this case, the latter is produced in one piece which is intended to enclose one of the ends of the heat pipes 5 and which is pierced with a plurality of holes through which pumping tubes 15 for filling these heat pipes with diphasic fluid pass. This part is produced conventionally by stamping or cold pressing a blank in order to obtain plugs with a small thickness.

By contrast, in FIG. 5, the filling plug is produced by the joining of two aluminum sheets, or sheets made of an aluminum alloy, which are cold-pressed and brazed together at their top, along the central plane of the device. The pressing of the sheets leaves indentations which are regularly disposed along the edge of the sheet that is intended to be joined to an edge of the other sheet, such that after assembly, there are openings 31 along the joining line 30 between the two sheets. These openings are positioned longitudinally along the joining line so as to be located facing internal cavities of the heat pipes 5 and to be able to serve for filling said internal cavities with cooling fluid. Thus, by way of syringes which are positioned for this purpose, they ensure the function of access to the inside of the heat pipes, this previously having been provided by pumping tubes 15. After the heat pipes have been filled, the openings 31 are closed by crimping and then the junction between them brazed in order to ensure that the internal part of the heat pipes is leaktight with respect to the outside.

In one particular embodiment of the invention, the heat exchanger 3 and the filling plug 6 are produced in the form of one and the same part, with the aim of reducing the number of parts employed and to facilitate the operations of manufacturing these parts. To this end, each aluminum sheet which forms one face of the filling plug 6 is made up of the extension of one of the aluminum sheets which forms a face of a tube 22 or 23; preferably, it is formed by the extension of the inner sheet or wall of the tube, that is to say the one which is intended to come into contact with the surfaces 12 or 13 of the heat pipes 5. Each half of the filling plug 6 is thus formed during the cold pressing operation, which serves to press the internal face of one of the constituent tubes of the heat exchanger.

The manufacture of a thermal control device according to the invention will now be described. All of the components of the thermal control device 1 are made a priori of aluminum material or of an aluminum alloy with a low melting point. In order to ensure that all of the components, notably the bundle of heat pipes 4, the filling plug 6 and evacuation plug 7, the heat exchanger 3 and the turbulators 24 thereof, the inlet nozzle 20 and outlet nozzle 21, are brazed together in one pass, provision is made for some components, the core of which is made of a sheet of aluminum, such as aluminum 3300, to be covered with a thin layer of material, such as aluminum 4040, 4045 or 4343 having a melting point lower than that of the core aluminum material. The makeup of this filler metal layer and its fixing to the aluminum sheets are defined such that it remains attached to said sheet during cold pressing operations. By acting as a filler metal, this thin layer of aluminum material (or “clad”), which has a thickness of only a few tenths of a millimeter, thus makes it possible to secure the components together, by fusion and migration, in a brazing oven (at a temperature of around 600° C.).

The parts in question for this layer of filler metal are:
the internal faces of the plugs 6 and 7, to which the ends of the external surfaces 12 or 13 of the heat pipes 5 are fixed,
the two faces of the inner sheets or walls of the tubes 22 and 23 of the heat exchanger 3, that is to say, for the one part, those that are intended to come into contact with the heat pipes 5, and, for the other part, a first set of crests of the waves of the turbulators 24,
and finally the internal face of the outer sheets or walls of the same tubes, to which the second set of crests of the waves of the disruptors 24 are fixed. The external face of the same outer sheets is not covered with filler metal while it is being made, so as to prevent it from sticking to the holding tool of any assembly, during brazing.

The filler metal is also present at the upper ends of the bulges 26 of the tubes 22 and 23, at the location at which the inlet nozzle 20 and outlet nozzle 21 of the heat exchanger 3 are fixed. Finally, in the case illustrated in FIG. 5, where the heat exchanger 3 and the filling plug 6 are combined in one and the same part, the filler metal situated on the internal face of the inner sheet is extended over the internal face of the half-plug 6 such that it can stick to the internal face of the other half-plug in order to ensure the closure (close to the openings 31) of the plug at its upper end.

The constituent parts of the thermal control device 1, which are preformed, are thus assembled in the following way.

In a first step, the turbulators 24 are inserted into the guide circuits of the respective tubes 22, 23 of the heat exchanger 3. The upper ends of the central bodies 8 of the heat pipes 5 are arranged in filling and shut-off plugs 6, 7 and, in the particular case of the embodiment illustrated in FIG. 4, the pumping tubes 15 are fitted on the filling plugs 6 of the heat pipes 5.

The heat pipes 5 and the tubes 22, 23 of the heat exchanger 3 are installed together in a tool for provisionally holding all of the components of the control device 1 together, with slight play of around of around 1/10 mm between each component, with the aim of allowing good migration of the filler metal. The inlet nozzle 20 and outlet nozzle 21 are also positioned next to inlet and outlet orifices of the heat transfer fluid on the bulges 26 of the two tubes.

Next, in a second step, the assembly obtained is brazed in order to secure the central multiduct bodies 8 to the filling plug 6 and shut-off plug 7 of the heat pipes 5, the turbulators 24 to the internal walls of the tubes 22, 23 of the heat exchanger 3, the tubes 22, 23 to the first ends 5a of the heat pipes 5 of the bundle 4, and the heat pipes 5 of the bundle 4 together, and also to secure the inlet and outlet nozzles to the tubes of the heat exchanger 3. If need be, the pumping tubes 15 can be secured to the filling plug 6.

Thus, all of the components preassembled on the tool are brazed in one operation, with ideal aluminum/aluminum contact between the components, that is to say without any risk of reducing the thermal conductivity, specifically in an entirely leaktight manner.

The control device 1 thus obtained is therefore easy to manufacture, and only requires the employment of components that have little bulk and are inexpensive. It allows the temperature to be maintained precisely and effectively, typically between 15° C. and 35° C. and more particularly between 20° C. and 30° C.

1. A thermal control device for a motor vehicle battery module, comprising:
a heat exchanger and a bundle of heat pipes having at least one surface intended to be in thermal contact both with a battery of the motor vehicle and with the heat exchanger,
said heat exchanger comprising at least one inner wall in contact with said surface of the heat pipes and at least one outer wall that delimits with said inner wall a circulation space for a fluid, wherein said inner and outer walls each comprise a plate.

2. The device as claimed in claim 1, wherein said plates are produced, from a metal sheet, by a cold forming operation and/or preassembled together by crimping so as to form said circulation space.

3. The device as claimed in claim 1, wherein said inner wall is covered on its two faces with a filler metal and said outer wall is covered with said filler metal on only one of its faces, situated facing said circulation space.

4. The device as claimed in claim 1, wherein said heat exchanger comprises two elements that each comprise an inner wall and an outer wall and are intended to be in thermal contact with two faces of said heat pipes.

5. The device as claimed in claim 4, wherein the two elements are in contact with one another by way of at least a part of their inner walls and are positioned with respect to one another following rotation through 180°.

6. The device as claimed in claim 5, wherein the circulation spaces of the two elements are brought into communication with one another, the heat exchanger comprising a single inlet nozzle and a single outlet nozzle.

7. The device as claimed in claim 4, wherein longitudinal ends of said plates comprise pressings at which the contact between the two elements is realized, the pressings of the plate forming the inner wall of said elements having an opposite orientation on each side of the corresponding plate so as to create a depression for accommodating a longitudinal end of the other element.

8. The device as claimed in claim 7, wherein said longitudinal ends of the elements that are fitted in said depressions comprise openings for the introduction of said inlet and/or outlet nozzles.

9. The device as claimed in claim 1, wherein the heat pipes are closed by a filling plug at their end situated by the heat exchanger.

10. The device as claimed in claim 9, wherein at least one wall of the filling plug is produced in one piece with at least one of the walls of said heat exchanger.

11. The device as claimed in claim 4, wherein the heat pipes are closed by a filling plug at their end situated by the heat exchanger, the filling plug being formed by wall extensions of the two elements of said heat exchanger, said wall extensions being assembled together.

12. The device as claimed in claim 11, wherein a joining line of said extensions comprises, along its length, openings that are able to form access points to the internal cavities of the heat pipes in order to fill them with fluid.

13. A motor vehicle battery module, comprising:
at least one battery; and
at least one thermal control device as claimed in claim 1.

14. The battery module as claimed in claim 13, further comprising at least two batteries that are stacked one on top of another with a thermal control device interposed between two successive batteries.

15. A method for manufacturing a thermal control device for a motor vehicle battery module as claimed in claim 13, wherein:
the heat pipes and the inner and outer walls of the element(s) intended to form the heat exchanger are manufactured separately,
said element(s) are closed by, if need be, positioning one or more disruptors beforehand inside the heat exchanger so as to form a circulation space for a heat transfer fluid, and
the assembly is brazed simultaneously.
